(19) United States
(12) Patent Application Publication
(10) Pub. No.: US 2018/0197055 A1
(43) Pub. Date: Jul. 12, 2018

(54) Luggage anti-lost wireless security card structure

(71) Applicant: Ching-Yin Lee, Taichung City (TW)

(72) Inventor: Ching-Yin Lee, Taichung City (TW)

(21) Appl. No.: 15/915,038

(22) Filed: Mar. 7, 2018

(30) Foreign Application Priority Data
May 4, 2017 (TW) 106206238

(51) Int. Cl. G06K 19/07; G06K 19/077

(52) U.S. Cl. CPC G06K 19/0701; G06K 19/07773

(57) ABSTRACT

A luggage anti-lost wireless security card structure includes a security card which is able to transmit a wireless signal containing a card number to the outside. An external wireless mobile device installed with a card number management APP is used to receive the wireless signal sent by the security card and to perform pairing, login, and management for the card number. When the security card is disposed in a suitcase or travel bag and the wireless mobile device carried by the owner of the luggage cannot normally receive or read the wireless signal of the security card, a warning signal is generated. When a person goes out with his/her luggage, he/she may use his/her wireless mobile device to detect the luggage. When the luggage is too far away from the person, a warning or reminder is generated to provide anti-theft and anti-lost functions.

### FIELD OF THE INVENTION

The present invention relates to a luggage anti-lost wireless security card structure applied to a suitcase or travel bag. A carry-on wireless mobile device may be used to detect the luggage. When the luggage is too far away from the user, a warning or reminder is generated to provide anti-theft and anti-lost functions.

### BACKGROUND OF THE INVENTION

In general, when people go out, they often use a suitcase or travel bag to carry their luggage. Suitcases and travel bags are large objects. When people waits for a bus/train at the bus/train station or wait for check-in at the airport, they have to pay attention to their luggage in order to prevent the luggage from being stolen or missing before getting on the bus/train or before boarding. Especially, when a person goes out or travels with his/her family, it is not easy to take good care of their luggage. Sometimes, the luggage may be stolen or lost. If the luggage (a suitcase or travel bag) is away from a certain distance, a simple tool is provided to generate a warning or reminder. This way can reduce the loss of the luggage. Accordingly, the inventor of the present invention has devoted himself based on his many years of practical experiences to solve these problems.

### SUMMARY OF THE INVENTION

The primary object of the present invention is to provide a luggage anti-lost wireless security card structure. The luggage anti-lost wireless security card structure comprises a security card composed of a thin upper cover and a thin base. The security card is provided with a card number wireless transmitter, a power supply unit, an antenna and a switch disposed in an accommodation space defined between the upper cover and the base. The card number wireless transmitter has at least a built-in card number and is electrically connected to the power supply unit, the antenna and the switch. The card number wireless transmitter can obtain the working power from the power supply unit and can transmit a wireless signal containing the card number from the antenna to the outside under the starting operation of the switch. An external wireless mobile device installed with a card number management APP is used to receive the wireless signal sent by the security card and to perform pairing, login, and management for the card number. When the security card is disposed in a suitcase or travel bag and the wireless mobile device carried by the owner of the luggage cannot normally receive or read the wireless signal of the security card, a warning signal is generated. When a person goes out with his/her luggage, he/she may use his/her wireless mobile device to detect the luggage. When the luggage is too far away from the person, a warning or reminder is generated to provide anti-theft and anti-lost functions.

Another object of the present invention is to provide a luggage anti-lost wireless security card structure, wherein, the card number wireless transmitter is a Bluetooth® wireless transmitter with the built-in card number. The external wireless mobile device has a built-in Bluetooth® wireless receiver receives a Bluetooth® wireless signal sent by the card number wireless transmitter and performs pairing, login, and management for the card number. When the wireless mobile device cannot receive or read the wireless signal transmitted from the security card, the wireless mobile device automatically generates a warning signal. The wireless mobile device may be a smart phone that includes a touch screen and a loudspeaker and is installed with a management APP of the security card. When the wireless mobile device receives the wireless signal of the security card for the first time, the touch screen can be used to perform pairing, login and edit management of the card number. During the process of receiving the wireless signal, if the wireless signal of the security card cannot be received or read, and the card number registered in the management menu is not connected, the warning signal is output to trigger the loudspeaker to issue a warning sound and/or display a warning message on the touch screen.

Another object of the present invention is to provide a luggage anti-lost wireless security card structure, wherein, the card number wireless transmitter has a built-in card number and a pairing authentication code, so that the wireless mobile device receives the wireless signal sent by the card number wireless transmitter from the security card. The wireless mobile device must write or input the pairing authentication code to perform pairing, login, and management for the card number, so that the security card in the suitcase or travel bag can be used to pair the wireless mobile device for performing use management thereby achieving the safety benefits that must be certified. The card number wireless transmitter is electrically connected to a pairing device. The authentication code of the card number wireless transmitter is set or operated by the pairing device to be sent or closed so that the security card can be set to limit one or more wireless mobile devices to perform pairing for use.

### BRIEF DESCRIPTION OF THE DRAWINGS

FIG. 1 is a perspective view of the present invention;

FIG. 2 is a block diagram showing the internal structure of the security card of the present invention; and

FIG. 3 is a schematic view showing the pairing of the security card of the present invention and the wireless mobile device.

### DETAILED DESCRIPTION OF THE PREFERRED EMBODIMENTS

Embodiments of the present invention will now be described, by way of example only, with reference to the accompanying drawings.

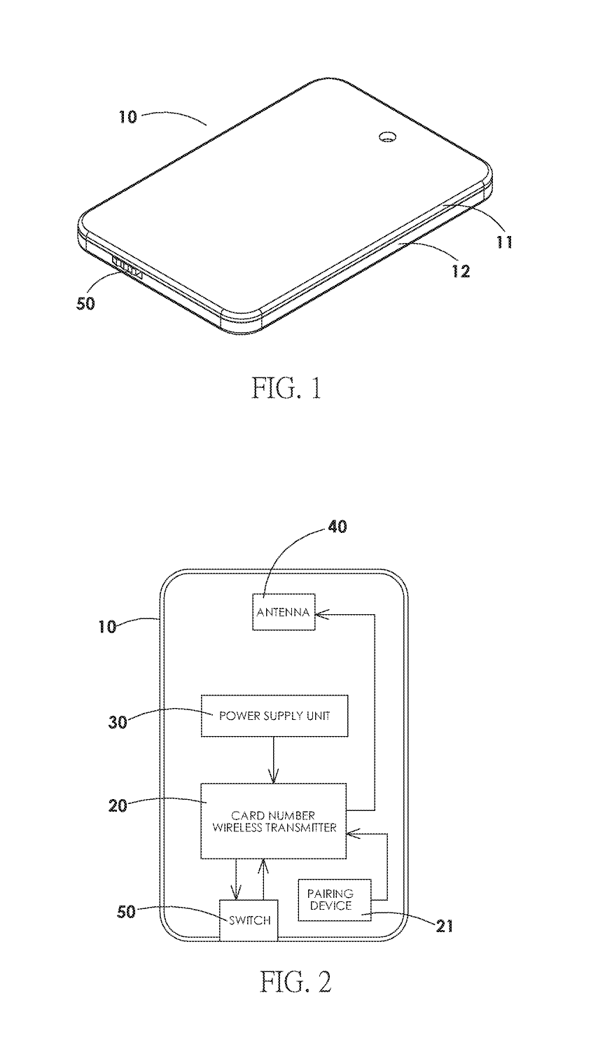

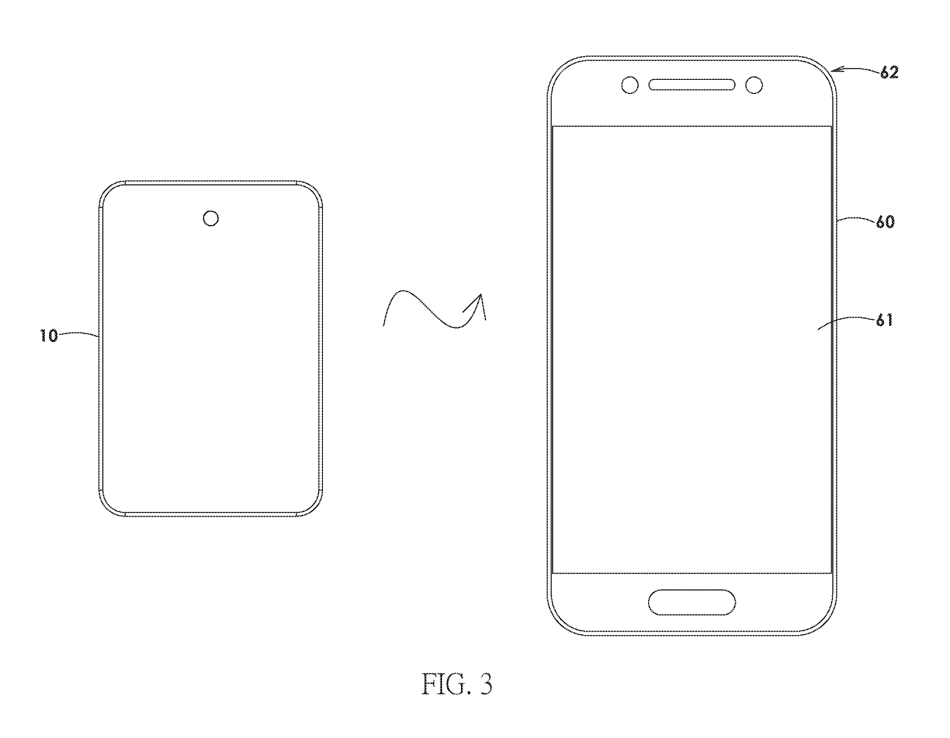

Referring to FIG. 1 and FIG. 2, a luggage anti-lost wireless security card structure according to a preferred embodiment of the present invention comprises a security card 10 composed of a thin upper cover 11 and a thin base 12. The security card 10 is provided with a card number wireless transmitter 20, a power supply unit 30, an antenna 40 and a switch 50 disposed in an accommodation space defined between the upper cover 11 and the base 12. The card number wireless transmitter 20 has at least a built-in card number and is electrically connected to the power supply unit 30 (which may be a battery), the antenna 40 and the switch 50. The card number wireless transmitter 20 can obtain the working power from the power supply unit 30 and can transmit a wireless signal containing the card number from the antenna 40 to the outside under the starting operation of the switch 50. As shown in FIG. 3, an external wireless mobile device 60 installed with a card number management APP is used to receive the wireless signal sent by the security card 10 and to perform pairing, login, and management for the card number. When the security card 10 is disposed in a suitcase or travel bag (not shown) and the wireless mobile device 60 carried by the owner of the luggage cannot normally receive or read the wireless signal of the security card 10, a warning signal is generated. When a person goes out with his/her luggage, he/she may use his/her wireless mobile device 60 to detect the luggage (with the security card 10). When the luggage (with the security card 10) is too far away from the person, a warning or reminder is generated to provide anti-theft and anti-lost functions.

According to the foregoing embodiment, as shown in FIG. 2 and FIG. 3, the card number wireless transmitter 20 is a Bluetooth® wireless transmitter with the built-in card number. The external wireless mobile device 60 has a built-in Bluetooth® wireless receiver (not shown) receives a Bluetooth® wireless signal sent by the card number wireless transmitter and performs pairing, login, and management for the card number. When the wireless mobile device 60 cannot receive or read the wireless signal transmitted from the security card 10, the wireless mobile device 60 automatically generates a warning signal. As shown in FIG. 3, the wireless mobile device 60 may be a smart phone that includes a touch screen 61 and a loudspeaker 62 and is installed with the management APP of the security card 10. When the wireless mobile device 60 receives the wireless signal of the security card 10 for the first time, the touch screen 61 can be used to perform pairing, login and edit management of the card number. During the process of receiving the wireless signal, if the wireless signal of the security card 10 cannot be received or read, and the card number registered in the management menu is not connected, the warning signal is output to trigger the loudspeaker 62 to issue a warning sound and/or display a warning message on the touch screen 61.

According to the foregoing embodiment, as shown in FIG. 2 and FIG. 3, the card number wireless transmitter 20 has a built-in card number and a pairing authentication code, so that the wireless mobile device 60 receives the wireless signal sent by the card number wireless transmitter from the security card 10 The wireless mobile device 60 must write or input the pairing authentication code to perform pairing, login, and management for the card number, so that the security card 10 in the suitcase or travel bag (not shown) can be used to pair the wireless mobile device 60 for performing use management thereby achieving the safety benefits that must be certified. As shown in FIG. 3, the card number wireless transmitter 20 is electrically connected to a pairing device 21. The authentication code of the card number wireless transmitter 20 is set or operated by the pairing device 21 to be sent or closed so that the security card 10 can be set to limit one or more wireless mobile devices 60 to perform pairing for use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A luggage anti-lost wireless security card structure, comprising a security card composed of a thin upper cover and a thin base, the security card being provided with a card number wireless transmitter, a power supply unit, an antenna and a switch disposed in an accommodation space defined between the upper cover and the base; the card number wireless transmitter having at least a built-in card number and being electrically connected to the power supply unit, the antenna and the switch, the card number wireless transmitter obtaining a working power from the power supply unit and transmitting a wireless signal containing the card number from the antenna to the outside under a starting operation of the switch.

2. The luggage anti-lost wireless security card structure as claimed in claim 1, wherein the card number wireless transmitter is a Bluetooth® wireless transmitter with the built-in card number, an external wireless mobile device has a built-in Bluetooth® wireless receiver to receive a Bluetooth® wireless signal sent by the card number wireless transmitter and performs pairing, login, and management for the card number, when the wireless mobile device cannot receive or read the wireless signal transmitted from the security card, the wireless mobile device automatically generates a warning signal.

3. The luggage anti-lost wireless security card structure as claimed in claim 2, wherein the wireless mobile device is a smart phone that includes a touch screen and a loudspeaker and is installed with a management APP (application) of the security card.

4. The luggage anti-lost wireless security card structure as claimed in claim 1, wherein the card number wireless transmitter has a built-in pairing authentication code.

5. The luggage anti-lost wireless security card structure as claimed in claim 4, wherein the card number wireless transmitter is electrically connected to a pairing device.
